(19) United States
(12) Patent Application Publication
(10) Pub. No.: US 2001/0030470 A1
(43) Pub. Date: Oct. 18, 2001

(54) Appliance switching system

(76) Inventors: William H. Waugh, Naples, FL (US); Daniel T. Doyle, Naples, FL (US)

Correspondence Address: William E. Noonan, Post Office Box 07338, Fort Myers, FL, 33919, US

(21) Appl. No.: 09/844,943

(22) Filed: Apr. 27, 2001

Related U.S. Application Data
(60) Provisional application No. 60/200,414, filed on Apr. 28, 2000.

(51) Int. Cl. H02J 3/00

(52) U.S. Cl. 307/114

(57) ABSTRACT

An appliance switching system is used in combination with a duplex electric outlet having a first receptacle that is constantly energized and a second receptacle that is selectively energized and de-energized by operation of a wall switch. The system includes first and second plugs for electrically engaging the respective receptacles. A selectively energized electrical socket is connected to the first plug. A three-way switch assembly is connected between the first plug and the socket and is alternatable between opened and closed states. A pair of relays are responsive to operation of the wall switch and the actuator switch respectively for independently opening and closing the three-way switch assembly to respectively energize and de-energize the socket.

### RELATED APPLICATION

This application claims the benefit of U.S. Provisional patent application Ser. No. 60/200,414 filed Apr. 28, 2000.

### FIELD OF THE INVENTION

This invention relates to an appliance switching system, which enables a lamp or similar switched appliance to be controlled independently by a standard wall switch and a remote actuator switch regardless of the initial positioning of those switches.

### BACKGROUND OF THE INVENTION

Many residences employ duplex electrical outlets wherein one receptacle of the outlet is constantly energized or “hot” and the other receptacle of the outlet is selectively controlled by a wall switch. This allows an electrical device such as a lamp, which is plugged into the switched receptacle, to be turned selectively on and off either by means of the wall switch or a built-in switch on the appliance itself. Both switches must be turned on in order for the appliance to be operated. If either switch is off, the lamp or other appliance cannot be operated by means of the other switch.

The configuration described above presents a significant inconvenience and safety hazard in the home. For example, in a child's room, a bedside lamp is often provided with a built-in switch and is likewise operated by a wall switch mounted near the door of the room. If the lamp switch is turned off, it is thereafter impossible to operate the lamp using the wall switch. A parent or other adult entering the room at night must go directly to and turn on the lamp. Traversing the child's room at night can present a safety hazard because toys and/or furniture may present a tripping hazard. Similarly, if the child needs to get out of bed during the night and the lamp has already been turned off by the wall switch, he or she cannot then turn the lamp on using the lamp switch. Once again, the child must navigate through a darkened room to access the wall switch.

It is therefore desirable to provide a system for operating a lamp or other appliance independently from either a wall switch or a switch located at or near the appliance. It is also desirable for the user to be able to turn the appliance on and off at either switch regardless of the positioning of the switches.

Beck, U.S. Pat. No. 4,951,765 discloses a lamp control that enables a lamp to be operated independently by a wall switch and a lamp control switch. This product requires the use of a screw-in module which must be attached to the lamp for receiving a bulb. The device also requires the use of a power supply and flip-flop which must be activated by flipping the wall switch momentarily to provide power to the module. This is an inconvenient step that is easily forgotten thereby rendering the device ineffective. Moreover, the Beck product is limited for use in connection with lamps and does not accommodate additional appliances such as clock radios, which are often located in close proximity to a bedroom lamp.

### SUMMARY OF THE INVENTION

It is therefore an object of the present invention to provide an appliance switching system, which enables a lamp or other appliance to be effectively and independently operated from multiple locations.

It is a further object of this invention to provide an appliance switching system which permits an appliance to be turned on and off independently by either a wall switch or an actuator switch located proximate to the appliance.

It is a further object of this invention to provide an appliance switching system that allows the appliance to be turned on and off at either of two independent switch locations regardless of the initial switch positions and, specifically, which permits the appliance to be turned on even if one of the switches is in the “off” position and alternatively turned “off” even if one of the switches is in an “on” position.

It is a further object of this invention to provide an appliance switching system that simply and effectively converts a single pole switching system into a more convenient three-way switching system.

It is a further object of this invention to provide an appliance switching system that simply and effectively converts a three-way switch system into a much more convenient four-way system.

It is a further object of this invention to provide an appliance switching system that greatly improves household safety.

It is a further object of this invention to provide an appliance switching system that significantly reduces the safety hazards associated with navigating a darkened room.

It is a further object of this invention to provide an appliance switching system that is simpler to install and use than existing systems.

It is a further object of this invention to provide an appliance switching system that is much simpler to operate than existing systems and does not require power sources, flip-flops or momentary wall switch operation in order to activate the system.

It is a further object of this invention to provide an appliance switching system that does not require the manufacture of complicated circuitry or complex re-wiring.

This invention features an appliance switching system for use in combination with a duplex electric outlet having a first receptacle that is constantly energized and a second receptacle that is selectively energized and de-energized by operation of a wall switch. The system includes a first plug for electrically engaging the first receptacle. There is a second plug for electrically engaging the second receptacle. A selectively energized electrical socket is connected to a three-way switch assembly, which electrically connects the first plug to the socket. The switch assembly is alternatable between open and closed states. An actuator switch is electrically connected to the first plug. First actuator means are interconnected between the second plug and the socket and are responsive to energization and de-energization of the second plug. Second actuator means are connected between the actuator switch and the first plug and are responsive to operation of the actuator switch. The first and second actuator means independently open and close the three-way switch assembly to respectively energize and de-energize the selectively energized socket.

In a preferred embodiment, the system further includes a second electrical socket connected to the first plug for being constantly energized when the first plug is engaged with the first receptacle of the outlet. A selector switch may be provided for selectively connecting one of the plugs with the selectively energized socket and the other plug with the second, constantly energized socket.

The first and second actuator means may include respective relays. In particular, the first actuator means may include a first relay that is respectively energized and de-energized in response to energization and de-energization of the second plug for alternating the state of the three-way switch assembly. The second actuator means may include a second relay that is alternately energized and de-energized in response to operation of the actuator switch for alternating the state of the three-way switch assembly. The actuator switch may include a single pole, a single throw switch. Various other types of switches, such as a single pole, double throw switches may also be employed.

The system may include a plug housing that carries and exposes the first and second plugs and the selectively and constantly energized sockets. Preferably, the three-way switch assembly and the first and second actuator means are enclosed by the housing. The system may further include a switch enclosure for accommodating the actuator switch and cable means for joining the housing and the switch enclosure, and electrically connecting the actuator switch and the first plug.

### DETAILED DESCRIPTION OF PREFERRED EMBODIMENTS

Other objects, features and advantages will occur from the following description of a preferred embodiment and the accompanying drawings, in which:

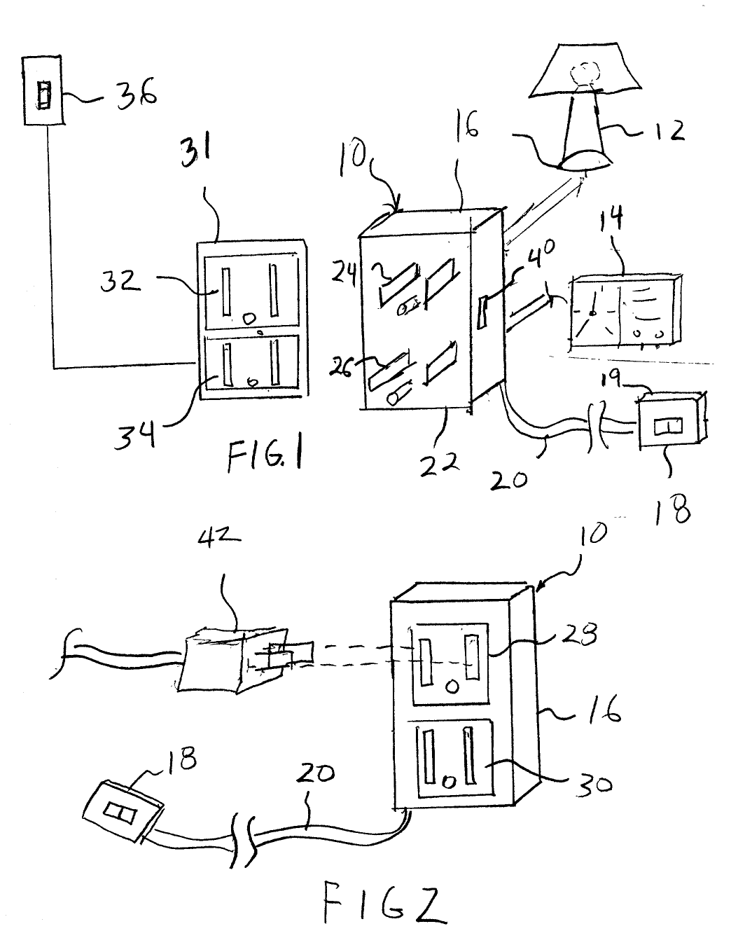

FIG. 1 is a simplified perspective view of a preferred switching system according to this invention with connections to the appliances and wall switch shown; the control unit is orientated to illustrate the first and second plugs;

FIG. 2 is an alternative perspective view of the switching system with the control unit orientated to depict the selectively and constantly energized sockets;

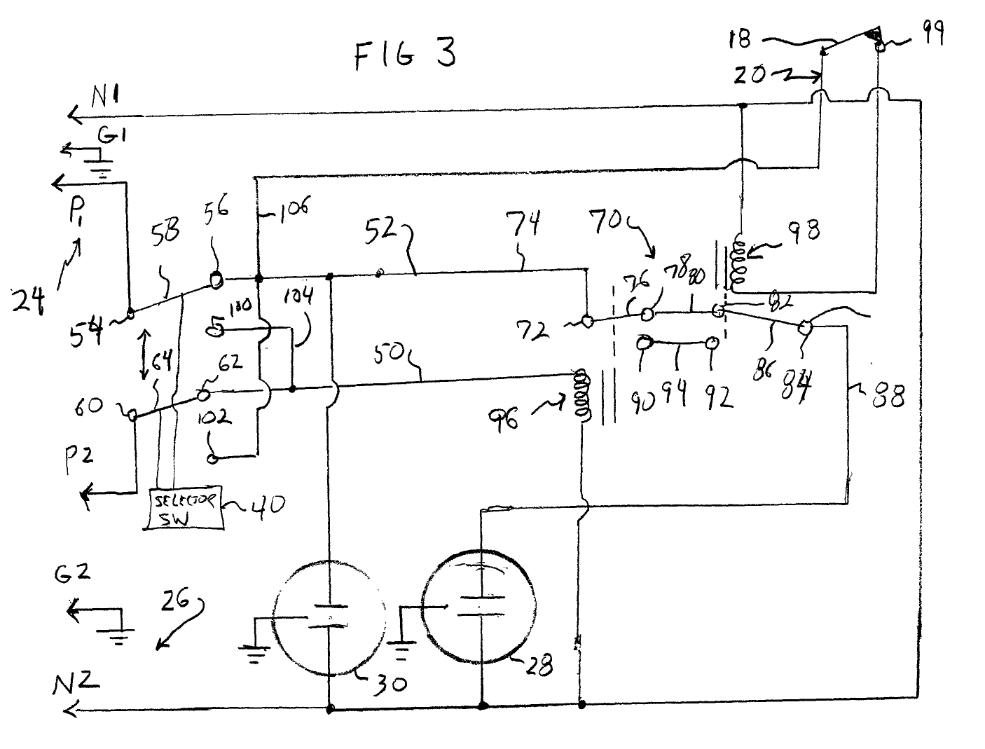

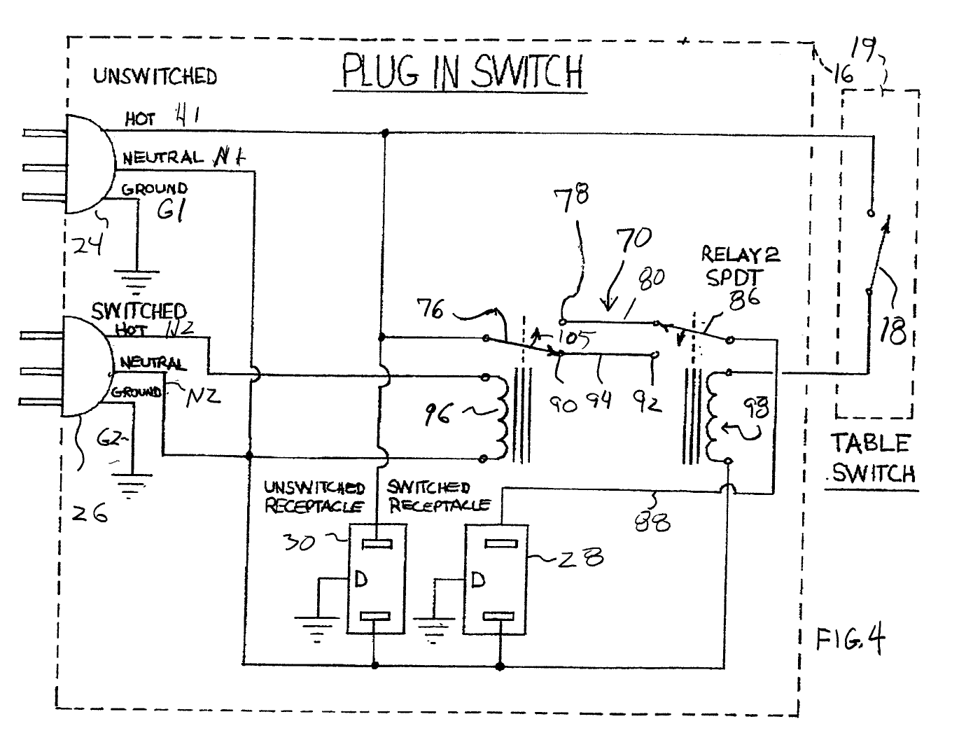

FIG. 3 is a schematic view of a preferred circuit that may be utilized in the switching system of this invention;

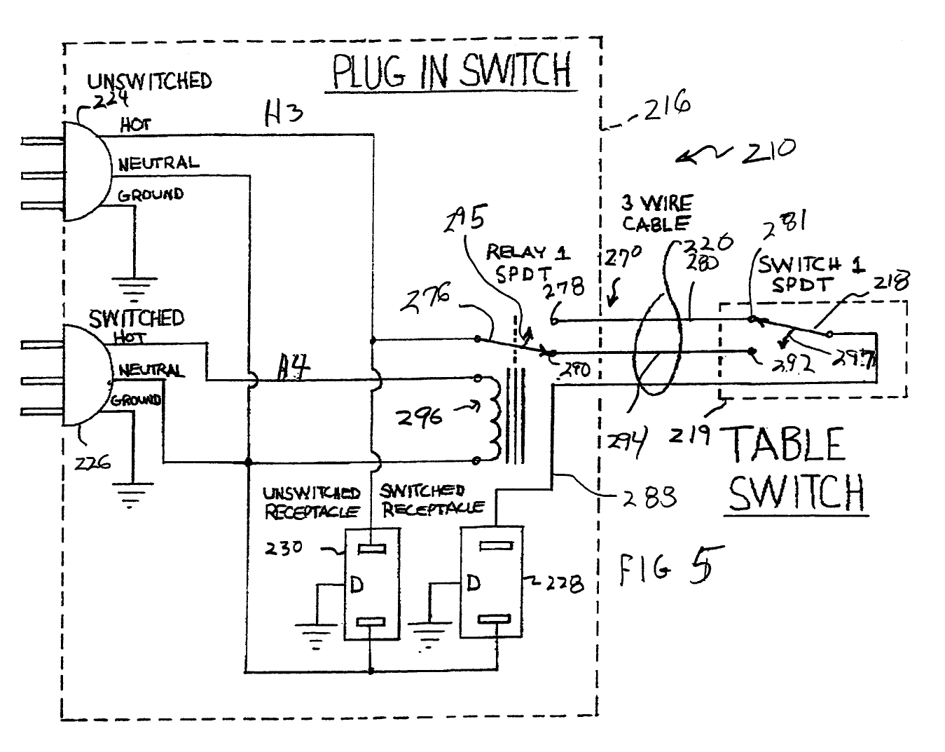

FIG. 4 is a schematic view of a circuit similar to that of FIG. 3 but without a selector switch; and

FIG. 5 is a schematic view of an alternative preferred switching circuit that may be used in this invention.

There is shown in FIGS. 1 and 2, an appliance switching system 10 that is designed for use in controlling the operation of one or more appliances such as a lamp 12 and a clock radio 14. It should be understood that a wide assortment of appliances may be controlled utilizing system 10. It is particularly preferred that the system be employed to provide switching control for a lamp. The system is not limited to such use, however, and may be used for controlling virtually any type of switchably operated electrical appliance.

System 10 specifically includes a control unit or module 16 and a remote actuator switch unit 18 that is electrically connected to control unit 16 by a standard electrical cable 20. Control unit 16 comprises a housing 22 which, as shown in FIG. 1, carries a pair of exposed, three-prong electrical plugs 24 and 26. As further illustrated in FIG. 2, a pair of standard electrical sockets 28 and 30 are mounted exposably in an opposing wall of housing 22. The plugs and sockets are electrically interconnected by appropriate circuitry within housing 22, in a manner that is described more fully below. The circuitry of switch 18 is mounted within an enclosure 19. Both housing 16 and enclosure 19 may be formed of a molded plastic or other suitable material.

Control unit 16 is designed to be plugged into a standard duplex electrical outlet 31 mounted in a wall or other structural surface. Outlet 31 includes a first receptacle 32 that is constantly energized (e.g. at 120 volts) by the building's electrical power supply. The second receptacle 34 is a switched receptacle that is selectively connected to the power supply by a standard toggle type wall switch 36. Assorted types of switches may be used to selectively energize switch receptacle 34. An electrical appliance is normally plugged into receptacle 32 so that it is constantly energized. A second appliance plugged into receptacle 34 is typically energized only when switch 36 is closed or turned on.

Unit 16 of system 10 plugs into receptacles 32 and 34 of duplex outlet 31. In particular, first plug 24 engages constantly energized receptacle 32 and second plug 26 connects into selectively energized receptacle 34. As a result, when control unit 16 is plugged into the duplex wall outlet, plug 24 is constantly energized (i.e. unswitched) and plug 26 is selectively energized by operation of wall switch 36 (i.e. switched). Sockets 28 and 30 are electrically connected to energized plug 24. As will be described more fully below, upper socket 28 is selectively energized and socket 30 is constantly energized as a result of appropriate circuitry and electrical interconnections within housing 22. It should be understood that, in alternative embodiments, the constantly and selectively energized household receptacles 32 and 34 may be reversed so that receptacle 32 is selectively energized by the wall switch and receptacle 34 is constantly energized by household wiring. Nonetheless, even in such cases, sockets 28 and 30 retain the same electrical characteristics. In such cases, the plugs 24 and 26 are effectively reversed by a selector switch 40, FIG. 1. Plug 26 (now the constantly energized plug) is connected to sockets 28 and 30. The selector switch may be slid or otherwise alternated between two positions, as described below, so that the switching system may be plugged into and operated with duplex outlets having a reversed arrangement and placement of switched and constantly energized receptacles. The details of this operation are described below.

The appliance to be switchably operated (e.g. lamp 12) is plugged into the switched or selectively energized socket 28. Specifically, as shown in FIG. 2, plug 42 of lamp 12 is inserted into socket 28 of control unit 16. The other appliance, which is designed for constant operation (e.g. clock radio 14), is plugged into the constantly energized (unswitched) socket 30. In this manner, when unit 16 is plugged into outlet 31, the clock radio operates continuously. At the same time, lamp 12 may be selectively turned on and turned off by either wall switch 36 or a remote actuator switch 18, which may be placed on a night table or otherwise close to the position of the lamp.

A preferred circuit diagram for switching system 10 is depicted in FIG. 3. Plug 24 includes energized (hot), ground and neutral leads or prongs P1, G1 and N1 respectively. Similarly, plug 26 features hot, ground and neutral leads P2, G2 and N2 respectively. Selector switch 40 alternates connection of each of plugs 24 and 26 between a selectively energized or switched circuit 50 and a constantly energized or unswitched circuit 52. In the embodiment shown in FIG. 3, pole 54 of constantly energized plug 24 is connected to pole 56 of circuit 52 through a closed switch arm 58. Similarly, pole 60 of selectively energized plug 26 is connected to pole 62 of circuit 50 through a closed switch arm 64. By operating selector switch 40 the plugs may be reversed when required so that plug 24 (when constantly energized) may be connected to circuit 50 and plug 26 is connected to circuit 52. This operation is described more fully below.

Circuit 52 includes the selectively energized or switched receptacle 28. A three-way switch assembly 70 is interconnected electrically between pole 56 and socket 28. The switch assembly includes a first contact 72 that is connected to wire 74 of circuit 52. In the state shown in FIG. 3, contact 72 is connected through a first switch arm 76 to a second contact 78. A wire or conductor 80 interconnects contact 78 to third switch contact 82, which in turn is connected to a fourth contact 84 by a second switch arm 86. Contact 84 is itself connected to a wire or conductor 88 of circuit 52. The latter conductor terminates at socket 28 which is also connected to neutral wire N2. Switch assembly 70 also includes fifth and sixth contacts 90 and 92 that are interconnected by a conductor 94. In FIG. 3, the switch arms 76 and 86 are shown engaged with contacts 78 and 82 and disengaged from contacts 90 and 92 respectively. Switching assembly 70 is operated in the manner described below such that switch arm 76 is selectively alternated between contacts 78 and 90, and switch arm 86 is similarly alternated between contacts 82 and 92 to operate (open and close) the three-way switch assembly.

Circuit 50 includes an actuator relay 96 that is interconnected electrically to plug 26. Relay 96 responds to energization and de-energization of plug 26 (i.e. turning on and off of wall switch 36, FIG. 1) by alternating switch arm 76 between contacts 90 and 78 respectively. In FIG. 3, plug 26 is de-energized (i.e. wall switch 36, FIG. 1, is turned off) such that the coil of relay 96 is de-energized and switch arm 76 is engaging contact 78.

Constantly energized socket 30 is interconnected between conductor 74 of circuit 52 and neutral conductor N2. As a result, when switch arm 58 contacting pole 56 and plug 24 is energized, power is provided to constantly energize socket 30. The socket is thereby capable of receiving the plug of a clock radio or other appliance which requires constant energization.

Actuator switch 18 is connected to constantly energized plug 24, likewise through pole 56. A second actuator relay 98 is interconnected between contact 99 of switch 18 and neutral conductor N1 of plug 24. As a result, when switch 18 is closed, as shown in FIG. 3, power is provided through the switch to energize the coil of relay 98. Conversely, when switch 18 is open, relay 98 is de-energized. Energization and de-energization of relay 98 causes switch arm 86 of three-way switch assembly 70 to alternate between contacts 82 and 92 respectively of switch assembly 70. In FIG. 3, switch 18 is closed such that relay 98 is energized and switch arm 86 is pulled into engagement with contact 82.

In operation, control unit 16, FIG. 1, is plugged into outlet 30 so that plug 24 engages constantly energized receptacle 32 and plug 26 engages switch and receptacle 34. The selector switch 40 is maintained in or adjusted to the position illustrated in FIG. 3 such that plug 24 is connected to circuit 52 and plug 26 is connected to circuit 50. Lamp 12, FIGS. 1 and 2, or another switched appliance is attached to switched socket 28 and clock radio 14 or another unswitched appliance is connected to constantly energized socket 30.

The lamp may be operated independently by either wall switch 36, FIG. 1, or remote actuator switch 18, FIGS. 1-3. Initially, the integral lamp switch that is built into the appliance should be left in a “on” condition. See FIG. 3. Plug 24 provides power over wire 74 to pole 72 of switch assembly 70. With wall switch 36 in a “off” condition, no power is provided through relay 96 (see FIG. 3). As a result, pole 72 is connected to pole 78 through switch arm 76. With remote switch 18 closed, as shown, relay 98 is energized to maintain switch arm 86 in contact with pole 82. As a result, power travels across wire 80, switch arm 86 and wire 88 to socket 28. This energizes the socket so that plugged in lamp 12 is illuminated.

Lamp 12 may be turned off by operating either wall switch 36 or remote bedside actuator switch 18. For example, if switch 36 is turned from “off” to “on”, relay 96 (FIG. 3) is energized. This causes switch arm 76 to be disengaged from pole 78 and pulled into engagement with pole 90. As a result, the three-way switch assembly is open and power from plug 24 is interrupted to socket 28. The socket and therefore the lamp are thereby de-energized. Alternatively, the lamp may be turned off by opening actuator switch 18. This de-energizes relay 98. As a result, switch arm 86 disengages pole 82 and instead engages pole 92. Switch assembly is again opened to de-energize socket 28.

Conversely, switching system 10 may be operated by either wall switch 36 or actuator switch 18 to turn on a previously de-energized lamp. In the initially de-energized state, the configuration of switch assembly 70 is such that one of switch arms 76 and 86 engages conductor 80 and the other engages conductor 94 (i.e. relays 96 and 98 are either both energized or both de-energized). For example, if switch 18 is closed, as shown in FIG. 3, but, alternatively, plug 26 and relay 96 are energized, switch arm 76 contacts pole 90 and socket 28 is de-energized. The system is then operated to energize socket 28 and turn on the lamp by switching either wall switch 36 (FIG. 1) or the actuator switch 18. Specifically, the wall switch may be alternated from an “on” state to an “off” state. This de-energizes relay 96 and causes switch arm 76 to disengage pole 90 and instead engage pole 78. The switch assembly thereby maintains the configuration shown in FIG. 3 and power is supplied to energized socket 28. Alternatively, wall switch 36 may remain “on” and actuator switch 18 may be opened. This de-energizes relay 98 so that switch arm 86 switches into engagement with pole 92. Because switch arm 76 is engaging pole 90, power is provided to socket 28 through lower wire 94 of three-way switch assembly 70. Once again, the socket and the attached lamp are energized.

Occasionally, system 10 may be employed with an outlet wherein the constantly and selectively energized receptacles are reversed. In such cases, selector switch 40 is opened to effectively reverse the electrical characteristics of plugs 24 and 26. Plug 24 becomes a selectively energized or switched plug and plug 26 becomes the constantly energized or unswitched plug. Switch 40 may comprise a slide switch or other known type of switch. When the slide switch is operated to reverse the plug positions, switch arm 58 is alternated to engage terminal 100 (FIG. 3) and switch arm 64 is alternated to engage terminal 102. As a result, plug 24 is connected through wire 104 to switched circuit 50 and plug 26 is connected through wire 106 to both circuit 52 and actuator switch 18. The switching system then operates in a manner analogous to that described above. Plug 26 provides constant unswitched power to both three-way switch assembly 70 and remote switch 18; and plug 24 provides switched power (from wall switch 36) to relay 96. Once again, the lamp may be operated independently by operation of either the wall switch or the actuator switch.

In each version of this invention, the switched appliance (i.e. the lamp) may be turned selectively on and off by simply alternating the switch position of either the wall switch 36 or the actuator switch 18. Switching is performed reliably regardless of the initial positioning (on or off) of the respective switches. Operation of either switch 36 or switch 18 causes the three-way switch assembly 70 to change state (either open or close) so that the socket 28 is de-energized or energized as required. System 10 effectively provides the lamp with a three-way switching system to conveniently and versatility control operation of the lamp.

It should be understood that the switching circuitry disclosed herein may be altered within the scope of this invention. For example, the three-way switching assembly and associated actuator relays may comprise microelectronic components that will be understood to persons skilled in the art. The wires, conductors and components may be mounted on an appropriate printed circuit board.

Switching system 10 allows a lamp or other switched appliance to be operated conveniently and safely by means of either a wall switch or an actuator switch that can be positioned conveniently proximate to the appliance (i.e. on a night table or other bedside location). The appliance may be both turned on and turned off at either location by simply operating either switch. This invention eliminates the need for the user to navigate through a darkened room. The invention is much more versatile than known devices because it can be used not only with lamps but with various other switched appliances. Unswitched appliances can also be plugged into the system so that electrical outlets are used efficiently. Moreover, the user does not have to momentarily energize the switching system by flipping a wall switch up and down. Switching system 10 is therefore very convenient to use and employs circuitry that is simpler then and improved over the circuitry employed by the prior art.

A simpler circuit diagram without a selector switch is depicted in FIG. 4. Therein, the components that correspond to the components of FIG. 3 are assigned like numerical designations. Plug 24 includes hot, neutral and ground wires H1, N1 and G1 respectively. Switched or selectively energized plug 26 includes hot wire H2, neutral wire N2 and ground wire G2. Hot wire H1 is connected to three-way switch assembly 70 within unit 16 and is likewise connected to actuator switch 18 within enclosure 19. The hot wire H1 and neutral wire N1 are connected across unswitched socket 30 such that socket 30 is constantly energized when plug 24 is engaged with a constantly energized electrical receptacle.

Hot wire H2 and neutral wire N2 of switch plug 26 are connected across the coil of relay 96. As a result, relay 96 is energized by plug 26 when the wall switch is turned on. This causes switch arm 76 of three-way switch assembly 70 to engage pole 90.

As in the prior embodiment, a relay 98 is connected to switch 18. When switch 18 is closed, relay 98 is energized by hot wire H1 of unswitched plug 24. This pulls switch arm 86 of assembly 70 into engagement with pole 92.

The circuit is illustrated with the three-way switch assembly 70 and switch 18 both open in FIG. 4. As a result, switched receptacle 28 is de-energized and the lamp or other appliance attached to socket 28 is likewise de-energized. Subsequently, socket 28 may be turned on at either the wall switch (FIG. 1) or the remote actuator switch by operating either of those switches. For example, in state depicted in FIG. 4, the wall switch must be “on” because switch arm 76 is pulled by relay 96 into engagement with pole 90. In order to turn on the lamp or other appliance from wall switch 36, that switch must be switched into an “off” state. This causes switch arm 76 to move in the direction of arrow 105 and engage pole 78. Power is thereby provided through switch arm 76, wire 80 and switch arm 86 to wire 88. As a result, socket 28 and the attached appliance are energzied.

Alternatively, socket 28 may be energized by closing actuator switch 18. This will energize relay 98, which pulls switch arm 86 into contact with pole 92. Power from wire H1 is then transmitted through switch arm 76, wire 94 and switch 86 to wire 88. Once again, this energizes socket 28. Subsequently, socket 28 may be selectively de-energized and energized independently by operating either the wall switch or the remote switch.

FIG. 5 depicts an alternative appliance switching system 210 wherein only a single relay is employed. Once again, there is a control unit 216 that carries a constantly energzied unswitched plug 224 and a switched plug 226. Unit 216 also includes a switched receptacle 228 and an unswitched receptacle 230. An actuator switch 218 contained within switch enclosure 219 is connected to unit 216 by a three wire cable 220.

In this version, the control unit includes only a single relay 296 and switch 218 forms a part of the three-way switch assembly. This system is also depicted without a selector switch although it should be understood that in alternative embodiments, a selector switch may be employed in this single relay version as well. The selector switch is connected to the circuit in a manner analogous to that previously described.

Hot wire H3 is connected to unswitched socket 230 such that the unswitched socket is constantly energized. Hot wire H3 is also connected to switched socket 228 through a three-way switch assembly 270. In this version, the three-way switch assembly comprises a first relay actuated switch 276 that is connected by the coil of relay 296. The second switch of the three-way switch comprises actuator switch 218, which is connected remotely to unit 216. Switch 276 is a single pole double throw relay driven switch that is selectively engagable with poles 278 and 290. Pole 278 is connected through a conductor 280 to pole 281 of switch 218. In this embodiment, the remote switch 218 comprises a single pole double throw switch wherein the switch selectively engages pole 281 and 292. Poles 290 and 292 of cable 220 are connected by conductor 294. Switch 218 is connected to socket 228 by a conductor 288.

In operation, hot wire H3 constantly energizes socket 230 and likewise provides power to three-way switch assembly 270. A lamp or other appliance is plugged into socket 228 and switching system 210 enables the appliance to be switched on and off independently by either the wall switch or remove actuator switch 218. As previously described, switched plug 226 is connected into the switched wall receptacle of a duplex outlet. As a result, plug 226 is selectively energized and de-energized by turning the wall switch on and off respectively. In FIG. 5, the switched plug is depicted in an energized condition. Power is provided through hot wire H4 to the coil of relay 296. This energizes the relay such that switch 276 is pulled into interengagement with pole 290. At the same time, as depicted in FIG. 5, switch 218 is manually operated such that it is engaged with pole 281. As a result, three-way switch assembly 270 is open. No power is provided to socket 228 and the attached appliance is de-energzied.

As in the prior embodiment, switching system 210 is operated from either the wall switch 36 (FIG. 1) or the actuator switch to independently control operation of socket 228 and its attached appliance. For example, the three-way switch assembly may be closed to energize the lamp by switching the wall switch to a “off” state. This de-energizes conductor H4 and relay 296. As a result, switch 276 switches as indicated by arrow 295 into engagement with pole 278. Switches 276 and 218 are thereby serially connected so that power is provided to socket 228. Alternatively, the three-way switch assembly may be closed by manually operating switch 218 as indicated by arrow 297 such that switch 218 engages pole 292. Likewise, this closes the three-way switch assembly and energizes socket 228.

Conversely, the switched socket 228 may be de-energized by operating system 210 such that switches 276 and 218 are not serially connected. This may be accomplished from either the wall switch or the remote actuator switch. For example, the appliance is energized if the wall switch is on (i.e. switch 276 is in the position shown in FIG. 5) and switch 218 is engaged with pole 292. The appliance may then be de-energized from the wall switch by simply switching the wall switch off so that switch 276 switches into engagement with pole 278. Alternatively, socket 228 and the attached appliance may be de-energized by switching single pole double throw switch 218 into engagement with pole 281. This is accomplished, of course, from the location of the remote actuator switch. Alternative switching operations are performed in an analogous manner independently using either the wall switch (to control relay switch 276) or the remote actuator switch 218. The lamp or other appliance may be operated (turned on and off) from either the wall switch or actuator switch location by simply changing or reversing of switch to its opposite state so that the appliance is energized or de-energized as required. The operation and benefits of system 210 are analogous to those described in connection with the prior embodiment.

In either embodiment of this invention, the actuator switch may alternatively be operated by a remote controller that uses radio waves in a known manner to selectively open and close the actuator switch. In such cases the actuator switch may be mounted within the control unit and operated by a remote controller that is maintained proximate to the switched appliance or at another desired location.

From the foregoing it may be seen that the apparatus of this invention provides for an appliance switching system. While this detailed description has set forth particularly preferred embodiments of the apparatus of this invention, numerous modifications and variations of the structure of this invention, all within the scope of the invention, will readily occur to those skilled in the art. Accordingly, it is understood that this description is illustrative only of the principles of the invention and is not limitative thereof.

Although specific features of the invention are shown in some of the drawings and not others, this is for convenience only, as each feature may be combined with any and all of the other features in accordance with this invention.

Other embodiments will occur to those skilled in the art and are within the following claims:

What is claimed is:

1. An appliance switching system for use in combination with a duplex electric outlet having a first receptacle that is constantly energized and a second receptacle that is selectively energized and de-energized by operation of a wall switch, said system comprising:
a first plug for electrically engaging the first receptacle;
a second plug for electrically engaging the second receptacle;
a selectively energized electrical socket;
a three-way switch assembly electrically connected between said first plug and said selectively energized socket and being alternatable between open and closed states;
an actuator switch electrically connected to said first plug; and
a first electrical actuator connected to said second plug and responsive to energization and de-energization of said second plug and a second electrical actuator connected between said actuator switch and said first plug and responsive to operation said actuator switch for independently closing and opening said three-way switch assembly to respectively energize and de-energize said socket.

2. The system of claim 1 further including a second electrical socket connected to said first plug for being constantly energized when said first plug is engaged with the first receptacle of the outlet.

3. The system of claim 2 further including a selector switch for selectively connecting one of said plugs to one of said switch assembly and said first actuator means and the other said plug to the other of said switch assembly and said first actuator means to selectively define said first and second plugs.

4. The system of claim 1 in which said first and second electrical actuators include respective relays.

5. The system of claim 1 in which said first actuator includes a first relay that is respectively energized and de-energized in response to energization and de-energization of said second plug for alternating the state of said three-way switch assembly.

6. The system of claim 1 in which said second actuator includes a second relay that is alternately energized and de-energized in response to operation of said actuator switch for alternating the state of said three-way switch assembly.

7. The system of claim 1 in which said actuator switch includes a single pole, single throw switch.

8. The system of claim 2 further including a housing that carries said first and second plugs and said selectively and constantly energized sockets, which are exposed by said housing, and that accommodates said three-way switch assembly and said first and second actuator means.

9. The system of claim 8 further including a switch enclosure for accommodating said actuator switch, and cable means for joining said housing and said switch enclosure and electrically connecting said actuator switch and said first plug.

10. An appliance switching system for use in combination with a duplex electric outlet having a first receptacle that is constantly energized and a second receptacle that is selectively energized and de-energized by operation of a wall switch, said system comprising:
a first plug for electrically engaging the first receptacle;
a second plug for electrically engaging the second receptacle;
a selectively energized electrical socket;
a three-way switch assembly electrically connected between said first plug and said socket and being alternatable between open and closed states;
an actuator switch electrically connected to said first plug and alternatable between open and closed states; and
a first relay connected to said second plug and responsive to energization and de-energization of said second plug, and a second relay connected between said actuator switch and said first plug and responsive to opening and closing of said actuator switch, said relays independently opening and closing said three-way switch assembly to respectively energize and de-energize said socket.

11. An appliance switching system for use in combination with a duplex electric outlet having a first receptacle that is constantly energized and a second receptacle that is selectively energized and de-energized by operation of a wall switch, said system comprising:
a first plug for electrically engaging the first receptacle;
a second plug for electrically engaging the second receptacle;
a selectively energized electric socket; and
a three-way switch assembly electrically connected between said first plug and said selectively energized socket and being alternatable between open and closed states, said assembly including a relay operated switch responsive to energization and deenergization of said second plug and an actuator switch alternatable between first and second states, said relay operated switch and said actuator switch being independently operated to selectively open and close said three-way switch and respectively energize and de-energize its socket.

12. The system of claim 11 further including a second electrical socket connected to said first plug for being constantly energized when said first plug is engaged with the first receptacle of the outlet.

13. The system of claim 12 further including a selector switch for selectively connecting one of said plugs to one of said relay operated switch and said actuator switch and the other said plug to the other of said relay operated switch and said actuator switch to selectively define said first and second plugs.

14. The system of claim 11 in which said actuator switch includes a single pole, double throw switch.

15. The system of claim 12 further including a housing that carries said first and second plugs and said selectively and constantly energized sockets, which are exposed by said housing, and that accommodates said relay operated switch.

16. The system of claim 15 further including a switch enclosure for accommodating said actuator switch, and cable means for joining said housing and said switch enclosure and electrically connecting said actuator switch and said first plug.
